(19) United States
(12) Patent Application Publication
(10) Pub. No.: US 2010/0207760 A1
(43) Pub. Date: Aug. 19, 2010

(54) MOBILE VEHICLE SCREENING (MVS)

(76) Inventor: Gerald D. STOMSKI, Woodbury, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/572,312

(22) Filed: Oct. 2, 2009

Related U.S. Application Data
(60) Provisional application No. 61/102,097, filed on Oct. 2, 2008.

(51) Int. Cl. G08B 21/00

(52) U.S. Cl. 340/540

(57) ABSTRACT

A mobile vehicle screening portal is provided having a trailer vehicle screening portal in combination a tractor toter. The trailer vehicle screening portal is configured in a transport mode to be transported to a location to screen vehicles, people or both, and is also configured in an operational mode with at least one screening station and modules configured to screen the vehicles, people or both when the trailer vehicle screening portal is deployed at the location. The tractor toter is configured to transport the trailer vehicle screening portal to the location, and is also configured with a command module to provide signaling containing information for remotely controlling the modules configured to screen the vehicles, people or both when the trailer vehicle screening portal is deployed at the location.

### CROSS REFERENCE TO RELATED APPLICATION

This patent application claims benefit to provisional patent application Ser. No. 61/102,097, filed 2 Oct. 2008, which is hereby incorporated by reference in its entirety.

### BACKGROUND OF THE INVENTION

1. Field of the Invention

This invention relates to a screening system; and more particularly to a screening system that may be temporary deployed when needed for screening vehicles at some location.

2. Description of Related Art

A multitude of screening systems are known in the art.

Due to the threat of terrorism throughout the world, there has increasingly developed a need for temporarily screening of vehicles at different short-term high security events, buildings/structures or locations—e.g. a presidential inauguration; high profile sporting event/venue like the Olympics, the Super Bowl, World Cup, etc.; bridges and tunnels in high risk cities; high profile building or structures like the White House, the Capitol, the Supreme Court, the US monuments, etc.; and/or checkpoints along certain local or foreign roads; etc. There has also increasingly developed a need for conducting such screening so as to eliminate or reduce the need for direct human contact with the vehicles being screened. In other words, there is a need for being able to perform such screening by one device or system located at one location that is operated and controlled, e.g., by a monitor or operator located at another location remote from the one location, so that if the vehicle is detonated the monitor or operator doing the screening is not likely to be injured, maimed or killed.

U.S. Pat. Nos. 6,474,599; 6,484,650 and 7,023,339 disclose other security systems developed by the inventor, which are all incorporated herein by reference in their entirety. By way of example, U.S. Pat. No. 7,023,339 discloses a transportable security portal for transporting on a flatbed of a trailer to a location for screening potential terrorists.

### SUMMARY OF THE INVENTION

The present invention provides a mobile vehicle screening portal featuring a trailer vehicle screening portal in combination a tractor toter. The trailer vehicle screening portal is configured in a transport mode to be transported to a location to screen vehicles, people or both, and is also configured in an operational mode with at least one screening station and modules configured to screen the vehicles, people or both when the trailer vehicle screening portal is deployed at the location. The tractor toter is configured to transport the trailer vehicle screening portal to the location, and is also configured with a command module to provide signaling containing information for remotely controlling the modules configured to screen the vehicles, people or both when the trailer vehicle screening portal is deployed at the location.

The mobile vehicle screening portal may include one or more of the following features: The modules may include sensor, detector or monitoring modules configured to detect explosives, weapons and/or hazardous materials. The modules may include sensor, detector or monitoring modules that have one or more of an infra-red camera, an x-ray machine, a detector of micro-millimeter waves, a chemical detector or a metal scanner. The modules may include one or more of an early warning detection/surveillance system, a radio frequency jamming device, an automatic entrance control gate, an X-ray vehicle screening device, a radiation/nuclear (RAD/NUC) detection device, an emergency alarm system, an audio voice control override, an automated LCD directional control light device or an automated emergency exit control light device. The modules may include control or controller modules configured to control the screening of the vehicles, people or both. The trailer vehicle screening portal may be configured as a mobile toll booth for screening the vehicles, people or both at the location, including as a mobile toll booth for screening the vehicles, people or both at the location using parallel lanes each having a respective screening station for providing multi-car processing. The trailer vehicle screening portal may take the form of a trailer that is about 72 feet long and configured to block a roadway when deployed cross-wise. The trailer vehicle screening portal may include portal entry walls on each side that can be opened or closed, e.g. by being raised and lowered, including where the portal entry walls on each side are raised and lowered in response to the signaling received from the command module. The trailer vehicle screening portal may be configured in the transport mode with the portal entry walls on each side are raised and secured shut for transport, or configured in the operational mode with the portal entry walls lowered to allow the vehicles, people or both to enter and exit the at least one screening station when the trailer vehicle screening portal is deployed at the location. The modules may be configured to screen the vehicles, people or both based on techniques of detection, mitigation and containment in relation to each vehicle or person being screened.

The tractor toter may include one or more of the following features: The tractor toter may be configured as a security housing to contain personnel for managing the screening of the vehicles, people or both when the trailer vehicle screening portal is deployed at the location. The command module may be configured to provide the signaling via wireless signaling, hardwire signaling, or both for remotely controlling the modules that provide for screening the vehicles, people or both when the trailer vehicle screening portal is deployed at the location. The command module may be configured to receive user inputs, e.g. from personnel managing the screening of the vehicles, people or both, and to provide the signaling for remotely controlling the modules based at least partly on the user inputs received. The scope of the invention is also intended to include receiving such user inputs via wireless signaling, e.g. via satellite, from another remote command location. The command module may be configured to receive monitoring signaling from one or more of the modules containing information about the screening of the vehicles, people or both when the trailer vehicle screening portal is deployed at the location.

The command module may be configured to provide access control signaling for screening the vehicles, people or both, including: i) providing entrance gate controller opening signaling to an entrance gate controller to open an entrance gate and allow a vehicle to drive up an entrance ramp and pass into the at least one screening station; ii) in response to monitoring signaling indicating that the vehicle has passed the entrance gate, providing entrance gate controller closing signaling to the entrance gate controller to close the entrance gate to contain the vehicle in the at least one screening station; iii) in response to monitoring signaling indicating that the screening is successfully completed for the vehicle or person, providing exit gate controller opening signaling to the exit gate controller to open the exit gate and allow the vehicle to exit the exit ramp and leave the at least one screening station; iv) in response to monitoring signaling indicating that the vehicle has passed the exit gate, providing the exit gate controller closing signaling to the exit gate controller to close the exit gate and prevent a next vehicle from exiting the exit ramp and leaving the at least one screening station; and v) repeating steps i to iv in order to screen the next vehicle.

The access control signaling may further include providing emergency exit gate controller closing signaling to an emergency exit gate controller to close an emergency exit gate and further prevent the vehicle from leaving the at least one screening station to further contain the vehicle in the trailer vehicle screening portal; in response to monitoring signaling indicating that the screening is successfully completed for the vehicle, providing emergency exit gate controller opening signaling to the emergency exit gate controller to open the emergency exit gate and allow the vehicle to leave the at least one screening station; and in response to monitoring signaling indicating that the vehicle has passed the emergency exit gate, providing the emergency exit gate controller closing signaling to the emergency exit gate controller to close the emergency exit gate and prevent the next vehicle from leaving the at least one screening station.

The access control signaling may further include providing directional control light signaling to control directional control lights to indicate that a driver of a vehicle or person may enter or exit the at least one screening station.

The signaling may further include providing mitigation control signalling to close portal entry walls and close the trailer vehicle screening portal to keep the vehicle in the at least one station and mitigate the damage that may result based at least partly on the detection of explosives, weapons and/or hazardous materials.

The present invention may also take the form of the command module consistent with that disclosed herein, featuring one or more modules configured to be arranged in a tractor toter that can transport a trailer vehicle having at least one screening station and monitoring modules configured to screen vehicles, people or both when deployed at a location, the one or more modules also being configured to provide signaling containing information for remotely controlling the monitoring modules in response to monitoring signaling received from at least one of the monitoring modules containing information about the screening of the vehicles, people or both. The command module may also include one or more of the features set forth above.

In operation, the mobile vehicle screening system provides a mobile access control platform used for screening vehicles at an undisclosed location. It is dimensioned and transported on a trailer alone as a single screening portal or with a plurality of security portals to provide screening for a short term high security event. The tractor or toter-vehicle which pulls and drives the trailer when not in use acts as a command module for the trailered screening portals by operating the integrated systems automatically at a safer distance. The command module is constructed in part using bomb-blast rated materials providing the security screeners additional safety from an occurred detonation. Monitors are secured to the exterior and interior walls of the portal to screen vehicles for explosives, radiation, weapons, illegal contraband, and stow-away individuals. The screening portals also include automated control gates which control movements of vehicles into and out of the portals. An emergency control devise is automatically activated prohibiting the vehicles from exiting the portal prematurely. Red, Green and Yellow LCD lights assist the vehicle operators in the forward movement of the vehicles being screened. Green, allows entrance into the screening portal. Red halts forward movement. Yellow indicates the screening process initiated. Green, allows forward movement out and exiting the screening portal. A audio over-ride system allows for the security screeners in the command module to have direct audio contact with the individuals in the vehicle. Data from the screening portals are transmitted via wireless or wired connection to the command module in real-time. The screening portals and command module operate on 110V and provides a secured backup generator and battery system whenever electricity is not available from utility lines.

In summary, the mobile vehicle screening system according to the present invention provides a new and unique system, apparatus, device or technique for temporarily screening of vehicles at such different short-term high security events, buildings/structures or locations. The mobile vehicle screening system according to the present invention also provides a new system, device or technique for conducting such screening so as to eliminate or reduce the need for direct human contact with the vehicles being screened, e.g. so as to be able to perform such screening by one device or system located at one location that is operated and controlled, e.g., by a monitor or operator located at another location remote from the one location, so that if the vehicle is detonated the monitor or operator doing the screening is not likely to be injured, maimed or killed.

### BRIEF DESCRIPTION OF THE DRAWING

The drawing, which is not to scale, includes the following Figures:

FIG. 1 is a side view perspective of a mobile vehicle screening portal having a tractor trailer toter and a trailer vehicle screening portal, which can operate as a mobile access control platform used for screening vehicles at an undisclosed location in a transport mode, and which is shown with the tractor-toter coupled to the trailer vehicle screening portal, according to some embodiments of the present invention.

FIG. 2 is a side view perspective of the trailer vehicle screening portal shown in FIG. 1, that is uncoupled from the tractor-toter in a set-up mode, according to some embodiments of the present invention.

FIG. 3 is a rear view of the trailer vehicle screening portal shown in FIG. 1 in an operational mode showing entrance and exit control ramps, automated entrance and exit control gates, and an automated emergency exit control gate, according to some embodiments of the present invention.

FIG. 4 shows a diagram of the mobile vehicle screening portal shown in FIG. 1 in a transport mode, according to some embodiments of the present invention.

FIG. 5 shows a diagram of the tractor toter when separated from the vehicle screening portal in a set-up mode, where the tractor-toter once uncoupled becomes a command module in the set-up mode which houses all security screeners and controls all operations for the integrated systems housed in the vehicle screening portal by remote control, according to some embodiments of the present invention.

FIG. 6 shows a diagram of the vehicle screening portal when separated from the tractor trailer toter in a set-up mode, where the vehicle screening portal once uncoupled becomes the mobile access control platform used for screening vehicles, according to some embodiments of the present invention.

FIG. 7 is a top view schematic of the trailer vehicle screening portal floor plan in an operational mode, showing exterior automated access control systems and the interior of the vehicle screening portal, according to some embodiments of the present invention.

FIG. 8 is a top view schematic of vehicles transitioning into and out of the vehicle screening portal in the operational mode, according to some embodiments of the present invention.

FIG. 9 is a block diagram of a schematic of a control sequencing between a command module and a controller of a vehicle screening portal according to some embodiments of the present invention.

### DESCRIPTION OF THE INVENTION

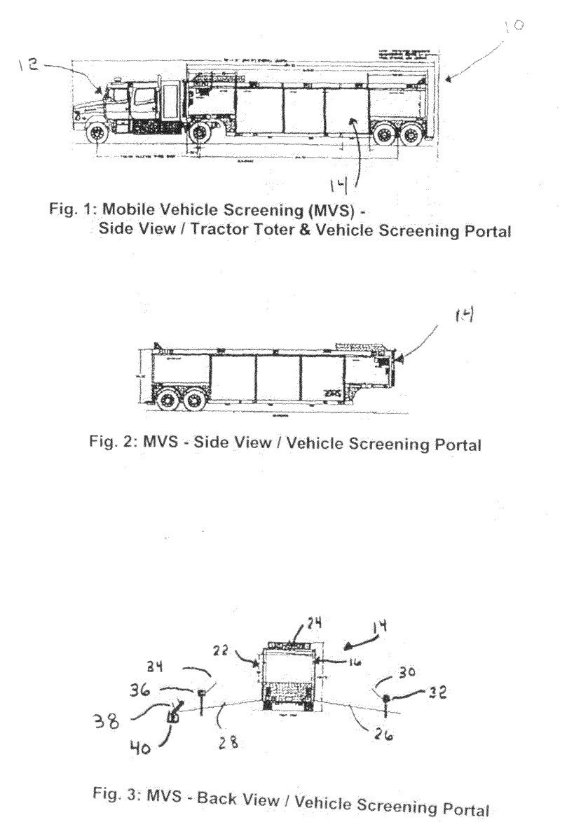

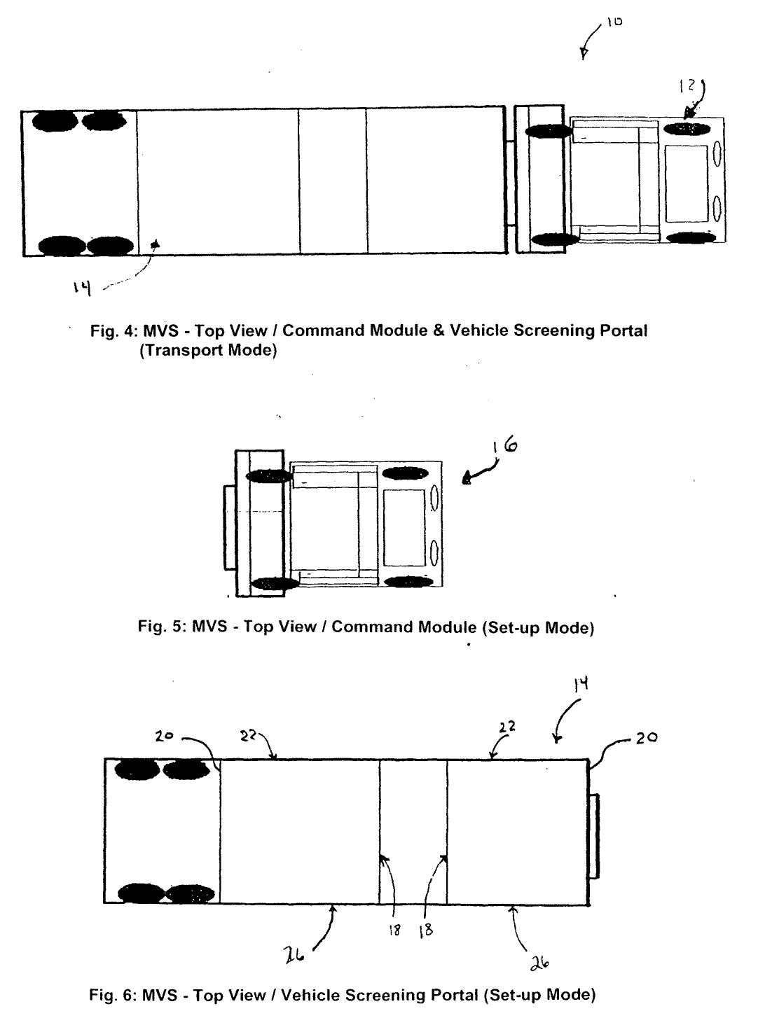

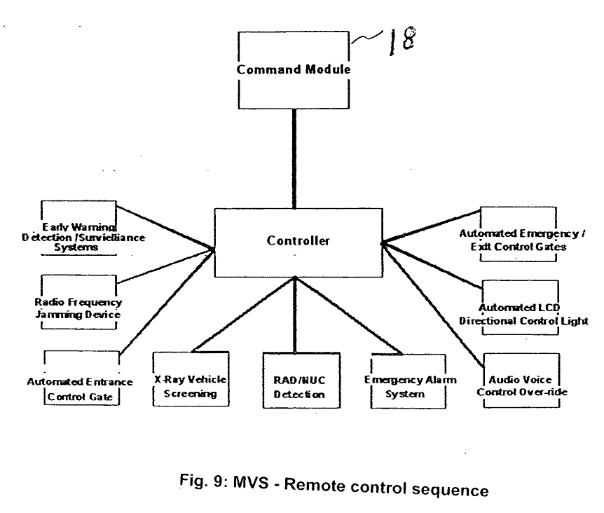

Referring to the drawing in detail, including FIGS. 1-9, a mobile vehicle screening portal for screening vehicles for explosives, weapons, illegal contraband, or stow-away individuals is shown and generally designated by the reference numeral 10, shown in FIG. 1. The mobile vehicle screening portal 10 includes a tractor-toter 12 that drives and pulls a trailer vehicle screening portal 14, e.g. to a screen location. When uncoupled the tractor-toter 12 becomes a command module system 16 (FIG. 5) at the screening location. The command module system 16 houses the screening personnel and includes a command module 18 (see FIG. 9) configured to provide signaling to remotely control the actions of all of the integrated systems in the trailer vehicle screening portal 14, so that the screening personnel are safely located away from the trailer vehicle screening portal 14 during screening. This is important because the screen personnel are situated away from the trailer vehicle screening portal 14 so that if there is a screen event, such as the detonation of a car bomb in or around the trailer vehicle screening portal 14, they are substantially more likely not to be injured by the same. The scope of the invention is not intended to be limited to the distance between the tractor tote when functioning as the command module system 16 and the vehicle screening portal 14 when in the operational mode. Moreover, the scope of the invention is intended to include the command module 18 and the vehicle screening portal 14 communicating using a wireless technology that may be encrypted or not, or a hard wired communication technique, as well as other communication techniques either now known or later developed in the future.

The trailer vehicle screening portal 14 (FIG. 3) includes portal entry walls 26, side portal walls 18, and opposed second side portal walls 20, portal exit walls 22, and a roof 24. The trailer vehicle screening portal 14 includes entrance control ramps 26, exit control ramps 28, an automated entrance control gate 30, an automated entrance gate controller 32, an automated exit gate 34, an automated exit gate controller 36, an automated emergency exit control gate 38, and an automated emergency exit gate controller 40.

In operation, the portal entry walls 26 and the portal exit walls 22 are raised during transit and lower during the operational mode so as to form respectively the entrance control ramp 26 and the exit control ramps 28. These walls 16 and 22 may be raised or lower manually, or via signaling received from the command module 18 that forms part of the tractor tote 12 when in the set-up mode. Portal entry and exit walls like elements 16 and 22 that raised and lower manually or via control signalling, e.g., from a remote control module, are known in the art, and the scope of the invention is not intended to be limited to any particular type or kind either now known or later developed in the future.

In operation, the raising and lowering of the automated entrance control gates 30 are controlled by the automated entrance gate controller 32, which are themselves via signaling received from the command module 18 that forms part of the tractor tote 12 when in the set-up mode. Similarly, in operation the raising and lowering of the automated exit control gates 34 are controlled by the automated exit gate controller 32, which are themselves controlled via signaling received from the command module 18 that forms part of the tractor tote 12 when in the set-up mode. Similarly, in operation the raising and lowering of the emergency control gates 38 are controlled by the automated emergency exit gate controllers 40, which are themselves controlled via signaling received from the command module 18 that forms part of the tractor tote 12 when in the set-up mode. Automated exit, entrance and emergency control gates like elements 30, 34 and 38, as well as controller like elements 32, 36 and 40, that raised and lower the same in response to control signalling, e.g., from a remote control module, are known in the art, and the scope of the invention is not intended to be limited to any particular type or kind either now known or later developed in the future.

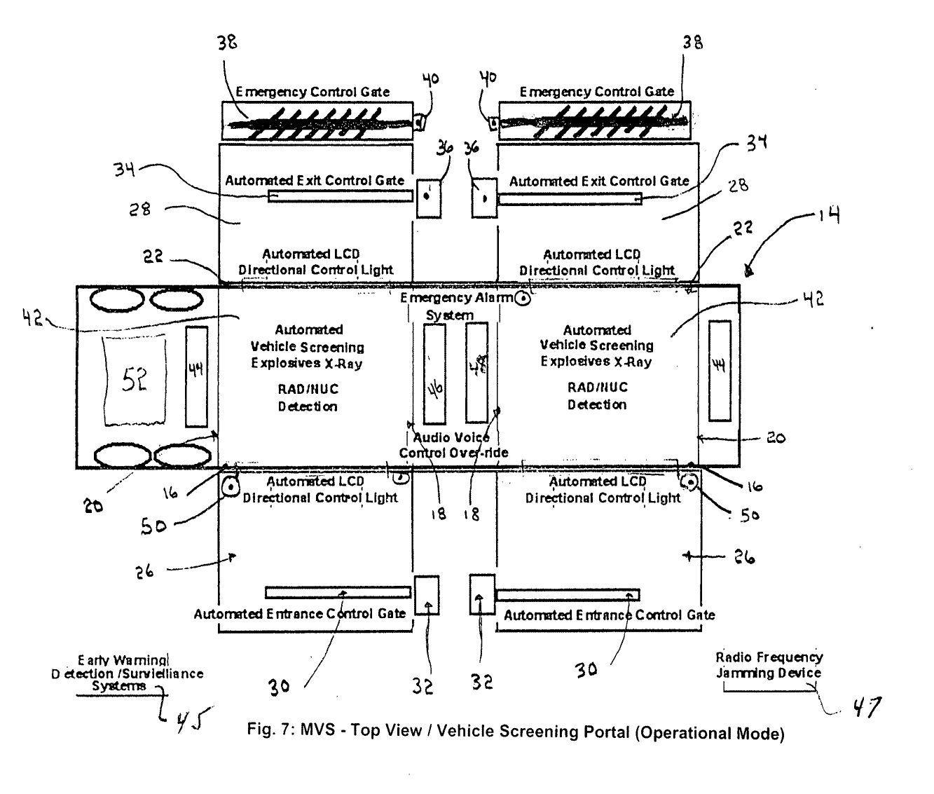

The trailer vehicle screening portal 14 also includes monitoring means for monitoring vehicles within screening stations 42, within the interior of the trailer vehicle screening portal 14, for detecting explosives, weapons, hazardous materials, or stow-away individuals within the interior of the vehicle. the monitoring means may consist of one or more sensor, detector or monitoring modules 44 (FIG. 7) located within the interior screening stations 42, such as infra-red cameras, x-ray machine, micro-millimeter waves, chemical detectors, metal scanners, early warning detection systems 45, radio frequency jamming devices 47 or may consist of an apparatus known in the art of security screening. The scope of the invention is not intended to be limited to any particular type or kind either now known or later developed in the future.

The trailer vehicle screening portal 14 includes an audio voice over-ride control system 46 configured for communication with occupants within a vehicle being screened, an automated emergency alarm system 48 that notifies screeners of premature exiting of the screening station 42. The entrance of the screening station 42 includes a series of automated LCD directional control lights 50 that assist vehicle operators in the forward movement and transitioning into and out of the screening station 42. Audio voice over-ride control systems like element 46, automated emergency alarm systems like element 48 and automated LCD directional control lights like element 50, including those operating in response to control signalling, e.g., from a remote control module, are known in the art, and the scope of the invention is not intended to be limited to any particular type or kind either now known or later developed in the future.

The trailer vehicle screening portal 14 includes a back up generator 52 that provides back up power to systems functions whenever 110v electricity is not available.

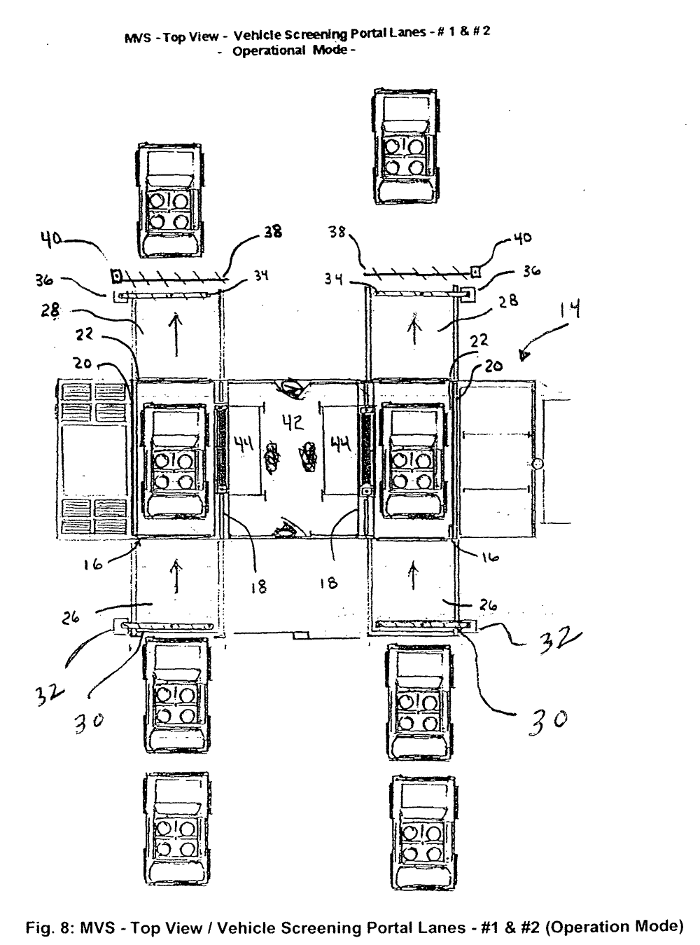

FIG. 8 shows the screen and passage of vehicles through the trailer vehicle screening portal 14. As shown, the trailer vehicle screening portal 14 is deployed cross-wise so as to allow vehicular screening through two channels or lanes. Each channel operates in the same basic way as shown and described herein, although embodiments are envisioned in which one channel is configured to screen one type of traffic, e.g. cars; while the other channel is configured to screen another type of traffic, e.g. people or special type of vehicles, etc. The scope of the invention is not intended to be limited to the type or kind of traffic being screened or the manner of screening.

The command module 18 that forms part of the trailer tote 16 is configured to provide signaling to the controller 32 to open the entrance gate 30 and allow each car to drive up the entrance ramp 26 and pass into the screening station 42, where the car is screened consistent with that described herein. During the screening, the controller 36 has received corresponding signaling to maintain the exit gate 34 in the closed position so as to contain the vehicle during screening. Once the screening is complete for each vehicle, the control module that forms part of the trailer tote 16 is configured to provide signaling to the controller 36 to open the exit gate 34 and allow each car to drive down the exit ramp 28 and leave the screening station 42. During the screening, the controller 40 may received corresponding signaling to maintain the emergency gate 38 in the closed position so as to further contain the vehicle during screening. The emergency gate 38 may also be of the type that can remain open, but can quickly and securely be closed during an emergency situation. Once the vehicle leaves the trailer vehicle screening portal 14, the next vehicle is screen using a similar set of steps.

FIG. 9 shows the command module 18 arranged in relation to a controller 19 that provides respective signaling to the early warning detection/surveillance system, the radio frequency jamming device, the automatic entrance control gate, the X-ray vehicle screening device, the radiation/nuclear (RAD/NUC) detection device, the emergency alarm system, the audio voice control override, the automated LCD directional control light device, the automated emergency exit control light device. The scope of the invention is intended to include the controller 19 being arranged in the tote trailer 12 or the trailer vehicle screening portal 14 for providing the respective signal to control the early warning detection/surveillance system, the radio frequency jamming device, the automatic entrance control gate, the X-ray vehicle screening device, the radiation/nuclear (RAD/NUC) detection device, the emergency alarm system, the audio voice control override, the automated LCD directional control light device, the automated emergency exit control light device. In the case where the controller 19 is located in the tote trailer 12, embodiments are envisioned in which the command module 18 and the controller 19 either form part of one module or are configured as separate modules as shown in FIG. 19. In the case where the controller 19 is located in the trailer screening portal 14, embodiments are envisioned in which the controller 19 is implemented as a separate module for controlling a corresponding device or system consistent with that shown in FIG. 7, or is implemented as a central controller for controlling all the systems or devices consistent with that shown in FIG. 19. The scope of the invention is not intended limited to the how the command module 18 and the controller 19 are arranged so as to control the early warning detection/surveillance system, the radio frequency jamming device, the automatic entrance control gate, the X-ray vehicle screening device, the radiation/nuclear (RAD/NUC) detection device, the emergency alarm system, the audio voice control override, the automated LCD directional control light device, the automated emergency exit control light device.

The following is a general description of that shown in the drawing, consistent with that set forth in the provisional application filing:

FIGS. 1-9 show a mobile vehicle screening system that is a mobile access control platform used for screening vehicles at an undisclosed location.

FIGS. 1-6 show one embodiment of the mobile vehicle screening system in the form of a trailer for being transported to such undisclosed location by a tractor as shown. By way of example, as shown the mobile vehicle screening system may be dimensioned and transported on a trailer alone as a single screening portal or with a plurality of security portals to provide screening for a short term high security event, building/structure or place. The tractor or toter-vehicle which pulls and drives the trailer when not in use acts as a command module for the trailered screening portals by operating the integrated systems automatically at a safer distance. The command module may be constructed in part using bomb-blast rated materials providing the security screeners additional safety from an occurred detonation.

FIGS. 7-8 show the mobile vehicle screening system once deployed at a particular location having two portals for vehicles to be allowed to enter the system, to be automatically screened and to be directed to exit the system once the screening is completed. Monitors are secured to the exterior and interior walls of the portals used to screen vehicles for explosives, radiation, weapons, illegal contraband, and stow-away individuals. The scope of the invention is not intended to be limited to any particular type or kind of screening or screening technique, and is intended to include both screening or screening technique now known or later developed in the future. The one or more screening portals also may include automated control gates which control movements of vehicles into and out of the portals. An emergency control devise is automatically activated prohibiting the vehicles from exiting the portal prematurely. By way of example, Red, Green and Yellow LCD lights may assist the vehicle operators in the forward movement of the vehicles being screened. Green may be used to allow entrance into the screening portal. Red halts forward movement. Yellow indicates the screening process initiated. Green may be used to allow forward movement out and exiting the screening portal. An audio over-ride system may allow for the security screeners in the command module to have direct audio contact with the individuals in the vehicle. Data from the screening portals may be transmitted via wireless or wired connection to the command module in real-time. The monitor or operator may be located in the command module deployed at some location remote from the trailer. The screening portals and command module may operate on 110V and provides a secured backup generator and battery system whenever electricity is not available from utility lines. The command module 18 may be located at a location far enough way so as not to be harmed by any such explosion, as well as a remote location receiving monitoring information, e.g., via a satellite or other long range communication signal.

FIG. 9 shows the command module 18 in combination with a controller for operating the mobile vehicle screening system, that includes various detection, jamming, control and screening systems, over-rides, gates, lights or devices. The various detection, jamming, control and screening systems, over-rides, gates, lights or devices are all known in the art, and the scope of the invention is not intended to be limited to any particular type or kind thereof either now known or later developed in the future. Moreover, the controller 19 for controlling and coordinating the various detection, jamming, control and screening systems, gates, lights or devices may be implemented in hardware, software, firmware or some combination thereof, and the scope of the invention is not intended to be limited to the same. In a typical software implementation, such a module may, by way of example, be implemented using one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future.

The scope of the invention is intended to include a method for performing the functionality set forth herein, a chipset for performing such functionality, including an Application Specific Integrated Circuit, as well as a computer program product or storage medium containing computer executable code for implementing the same on a device or system when such code is run on a computer or computer processor device.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What I claim is:

1. A mobile vehicle screening portal comprising:
a trailer vehicle screening portal configured in a transport mode to be transported to a location to screen vehicles, people or both, and also configured in an operational mode with at least one screening station and modules configured to screen the vehicles, people or both when the trailer vehicle screening portal is deployed at the location; and
a tractor toter configured to transport the trailer vehicle screening portal to the location, and also configured with a command module to provide signaling containing information for remotely controlling the modules configured to screen the vehicles, people or both when the trailer vehicle screening portal is deployed at the location.
Trailer

2. A mobile vehicle screening portal according to claim 1, wherein the modules comprise sensor, detector or monitoring modules configured to detect explosives, weapons and/or hazardous materials.

3. A mobile vehicle screening portal according to claim 1, wherein the modules comprise sensor, detector or monitoring modules that include one or more of an infra-red camera, an x-ray machine, a detector of micro-millimeter waves, a chemical detector or a metal scanner.

4. A mobile vehicle screening portal according to claim 1, wherein the modules comprise one or more of an early warning detection/surveillance system, a radio frequency jamming device, an automatic entrance control gate, an X-ray vehicle screening device, a radiation/nuclear (RAD/NUC) detection device, an emergency alarm system, an audio voice control override, an automated LCD directional control light device or an automated emergency exit control light device.

5. A mobile vehicle screening portal according to claim 1, wherein the modules comprise control or controller modules configured to control the screening of the vehicles, people or both.

6. A mobile vehicle screening portal according to claim 1, wherein the trailer vehicle screening portal is configured as a mobile toll booth for screening the vehicles, people or both at the location.

7. A mobile vehicle screening portal according to claim 1, wherein the trailer vehicle screening portal is configured as a mobile toll booth for screening the vehicles, people or both at the location using parallel lanes each having a respective screening station for providing multi-car processing.

8. A mobile vehicle screening portal according to claim 1, wherein the trailer vehicle screening portal takes the form of a trailer that is about 72 feet and configured to block a roadway when deployed cross-wise.

9. A mobile vehicle screening portal according to claim 1, wherein the trailer vehicle screening portal comprises portal entry walls on each side that can be raised and lowered.

10. A mobile vehicle screening portal according to claim 9, wherein the portal entry walls on each side are raised and lowered in response to the signaling received from the command module.

11. A mobile vehicle screening portal according to claim 9, wherein the trailer vehicle screening portal is configured in the transport mode with the portal entry walls on each side are raised and secured shut for transport.

12. A mobile vehicle screening portal according to claim 9, wherein the trailer vehicle screening portal is configured in the operational mode with the portal entry walls lowered to allow the vehicles, people or both to enter and exit the at least one screening station when the trailer vehicle screening portal is deployed at the location.

13. A mobile vehicle screening portal according to claim 1, wherein the modules are configured to screen the vehicles, people or both based on techniques of detection, mitigation and containment in relation to each vehicle or person being screened.
Tractor Toter

14. A mobile vehicle screening portal according to claim 1, wherein the tractor toter is configured as a security housing to contain personnel for managing the screening of the vehicles, people or both when the trailer vehicle screening portal is deployed at the location.

15. A mobile vehicle screening portal according to claim 1, wherein the command module is configured to provide the signaling via wireless signaling, hardwire signaling, or both for remotely controlling the modules that provide for screening the vehicles, people or both when the trailer vehicle screening portal is deployed at the location.

16. A mobile vehicle screening portal according to claim 1, wherein the command module is configured to receive user inputs from personnel managing the screening of the vehicles, people or both, and to provide the signaling for remotely controlling the modules based at least partly on the user inputs received.

17. A mobile vehicle screening portal according to claim 1, wherein the command module is configured to receive monitoring signaling from one or more of the modules containing information about the screening of the vehicles, people or both when the trailer vehicle screening portal is deployed at the location.

18. A mobile vehicle screening portal according to claim 1, wherein the command module is configured to provide access control signaling for screening the vehicles, people or both, including:
i) providing entrance gate controller opening signaling to an entrance gate controller to open an entrance gate and allow a vehicle to drive up an entrance ramp and pass into the at least one screening station;
ii) in response to monitoring signaling indicating that the vehicle has passed the entrance gate, providing entrance gate controller closing signaling to the entrance gate controller to close the entrance gate to contain the vehicle in the at least one screening station;
iii) in response to further monitoring signaling indicating that the screening is successfully completed for the vehicle or person, providing exit gate controller opening signaling to the exit gate controller to open the exit gate and allow the vehicle to exit the exit ramp and leave the at least one screening station;
iv) in response to still further monitoring signaling indicating that the vehicle has passed the exit gate, providing the exit gate controller closing signaling to the exit gate controller to close the exit gate and prevent a next vehicle from exiting the exit ramp and leaving the at least one screening station; and
v) repeating steps i to iv in order to screen the next vehicle.

19. A mobile vehicle screening portal according to claim 18, wherein the access control signaling further includes:
providing emergency exit gate controller closing signaling to an emergency exit gate controller to close an emergency exit gate and further prevent the vehicle from leaving the at least one screening station to further contain the vehicle in the trailer vehicle screening portal;
in response to monitoring signaling indicating that the screening is successfully completed for the vehicle, providing emergency exit gate controller opening signaling to the emergency exit gate controller to open the emergency exit gate and allow the vehicle to leave the at least one screening station; and
in response to monitoring signaling indicating that the vehicle has passed the emergency exit gate, providing the emergency exit gate controller closing signaling to the emergency exit gate controller to close the emergency exit gate and prevent the next vehicle from leaving the at least one screening station.

20. A mobile vehicle screening portal according to claim 18, wherein the access control signaling further includes:
providing directional control light signaling to control directional control lights to indicate that a driver of a vehicle or person may enter or exit the at least one screening station.

21. A mobile vehicle screening portal according to claim 1, wherein the signaling further includes:
providing mitigation control signalling to close portal entry walls and close the trailer vehicle screening portal to keep the vehicle in the at least one station and mitigate the damage that may result based at least partly on the detection of explosives, weapons and/or hazardous materials.
Command Module

22. A command module comprising:
one or more modules configured to be arranged in a tractor toter that can transport a trailer vehicle having at least one screening station and monitoring modules configured to screen vehicles, people or both when deployed at a location, the one or more modules also being configured to provide signaling containing information for remotely controlling the monitoring modules in response to monitoring signaling received from at least one of the monitoring modules containing information about the screening of the vehicles, people or both.

23. A command module according to claim 22, wherein the one or more modules is configured to provide the signaling via wireless signaling, hardwire signaling, or both for remotely controlling the monitoring modules.

24. A command module according to claim 22, wherein the one or more modules is configured to receive user inputs and to provide the signaling for remotely controlling the monitoring modules based at least partly on the user inputs received.

25. A command module according to claim 22, wherein the command module is configured to provide access control signaling for screening the vehicles, people or both, including:
i) providing entrance gate controller opening signaling to an entrance gate controller to open an entrance gate and allow a vehicle to drive up an entrance ramp and pass into the at least one screening station;
ii) in response to monitoring signaling indicating that the vehicle has passed the entrance gate, providing entrance gate controller closing signaling to the entrance gate controller to close the entrance gate to contain the vehicle in the at least one screening station;
iii) in response to further monitoring signaling indicating that the screening is successfully completed for the vehicle or person, providing exit gate controller opening signaling to the exit gate controller to open the exit gate and allow the vehicle to exit the exit ramp and leave the at least one screening station;
iv) in response to still further monitoring signaling indicating that the vehicle has passed the exit gate, providing the exit gate controller closing signaling to the exit gate controller to close the exit gate and prevent a next vehicle from exiting the exit ramp and leaving the at least one screening station; and
v) repeating steps i to iv in order to screen the next vehicle.

26. A command module according to claim 27, wherein the access control signaling further includes:
providing emergency exit gate controller closing signaling to an emergency exit gate controller to close an emergency exit gate and further prevent the vehicle from leaving the at least one screening station to further contain the vehicle in the trailer vehicle screening portal;
in response to monitoring signaling indicating that the screening is successfully completed for the vehicle, providing emergency exit gate controller opening signaling to the emergency exit gate controller to open the emergency exit gate and allow the vehicle to leave the at least one screening station; and
in response to monitoring signaling indicating that once the vehicle has passed the emergency exit gate, providing the emergency exit gate controller closing signaling to the emergency exit gate controller to close the emergency exit gate and prevent the next vehicle from leaving the at least one screening station.

27. A command module according to claim 25, wherein the access control signaling further includes:
providing directional control light signaling to control directional control lights to indicate that a driver of a vehicle or person may enter or exit the at least one screening station.

28. A command module according to claim 22, wherein the signaling further includes:
providing mitigation control signalling to close portal entry walls and close the trailer vehicle screening portal to keep the vehicle in the at least one station and mitigate the damage that may result based at least partly on the detection of explosives, weapons and/or hazardous materials.
